(19) United States
(12) Patent Application Publication
(10) Pub. No.: US 2025/0028507 A1
(43) Pub. Date: Jan. 23, 2025

(54) METHOD AND APPARATUS FOR PROCESSING INFORMATION, ELECTRONIC DEVICE AND STORAGE MEDIUM

(71) Applicant: Beijing Zitiao Network Technology Co., Ltd., Beijing (CN)

(72) Inventors: Junxin Zheng, Beijing (CN); Cheng Peng, Beijing (CN); Xinping Qiu, Beijing (CN)

(21) Appl. No.: 18/773,498

(22) Filed: Jul. 15, 2024

(30) Foreign Application Priority Data
Jul. 21, 2023 (CN) 202310907536.0

(51) Int. Cl. G06F 8/30

(52) U.S. Cl. CPC G06F 8/30

(57) ABSTRACT

The disclosure provides a method and apparatus for processing information, an electronic device and a storage medium. The method for processing information includes: determining a first field in a first table in response to a first operation event, where the first field corresponds to one or more first cells, and the one or more first cells have links recorded therein; determining a second field in the first table in response to a second operation event, where the second field corresponds to one or more second cells; and obtaining, in response to a third operation event, a target file pointed to by a link in a first cell corresponding to the first field, and displaying the target file in a second cell corresponding to the first cell.

### CROSS-REFERENCE TO RELATED APPLICATION(S)

This application claims priority to Chinese Application No. 202310907536.0 filed on Jul. 21, 2023, the disclosure of which is incorporated herein by reference in its entity.

### FIELD

The disclosure relates to the technical field of computers, and particularly relates to a method and apparatus for processing information, an electronic device and a storage medium.

### BACKGROUND

Tables, such as online table documents, can store various types of information, such as text information, link information, attachments, etc. In a table, a column of cells usually store the same type of information. For example, a field corresponding to a column of cells can be multi-line text or an attachment, and then the content stored in the column of cells is the multi-line text or the attachment.

### SUMMARY

The disclosure provides a method and apparatus for processing information, an electronic device and a storage medium.

The disclosure uses the following technical solution.

In some embodiments, the disclosure provides a method for processing information.

The method includes:
determining a first field in a first table in response to a first operation event, where the first field corresponds to one or more first cells, and the one or more first cells have link(s) recorded therein;
determining a second field in the first table in response to a second operation event, where the second field corresponds to one or more second cells; and
obtaining, in response to a third operation event, a target file pointed to by a link in a first cell corresponding to the first field, and displaying the target file in a second cell corresponding to the first cell.

In some embodiments, the disclosure provides an apparatus for processing information. The apparatus includes:
a determination unit, configured to determine a first field in a first table in response to a first operation event, where the first field corresponds to one or more first cells, and the one or more first cells have link(s) recorded therein, and
the determination unit is further configured to determine a second field in the first table in response to a second operation event, and the second field corresponds to one or more second cells; and
a control unit, configured to obtain, in response to a third operation event, a target file pointed to by a link in the first cell corresponding to the first field, and display the target file in a second cell corresponding to the first cell.

In some embodiments, the disclosure provides an electronic device. The electronic device includes at least one memory and at least one processor.

The memory is configured to store program code, and the processor is configured to call the program code stored in the memory to execute the above method.

In some embodiments, the disclosure provides a computer-readable storage medium. The computer-readable storage medium stores program code. The program code, when executed by a processor, causes the processor to execute the above method.

In some embodiments of the disclosure, the target files pointed to by the links are obtained in batches and written into the first table, such that operation efficiency of a user is improved, and the user does not need to manually download the target files pointed to by the links and input the target files into the first table one by one.

### BRIEF DESCRIPTION OF THE DRAWINGS

The above and other features, advantages, and aspects of embodiments of the disclosure will become more apparent with reference to the following particular embodiments in conjunction with the drawings. The same or similar reference numerals refer to the same or similar elements throughout the drawings. It should be understood that the drawings are schematic, and that the parts and elements are not necessarily drawn to scale.

FIG. 1 is a flowchart of a method for processing information according to an embodiment of the disclosure;

FIGS. 2, 3, and 4 are schematic diagrams of a display interface according to an embodiment of the disclosure; and

FIG. 5 is a schematic structural diagram of an electronic device according to an embodiment of the disclosure.

### DETAILED DESCRIPTION OF EMBODIMENTS

Embodiments of the disclosure are described in more detail below with reference to the drawings. Although some embodiments of the disclosure are shown in the drawings, it should be understood that the disclosure may be embodied in various forms and should not be construed as being limited to the embodiments set forth herein. On the contrary, these embodiments are provided, such that the disclosure will be understood more thoroughly and completely. It should be understood that the drawings and embodiments of the disclosure are for illustrative purposes merely and are not intended to limit the scope of protection of the disclosure.

It should be understood that various steps recited in the method embodiments of the disclosure can be executed in orders and/or in parallel. Furthermore, the method embodiments can include additional steps and/or omit to execute the illustrated steps. The scope of the disclosure is not limited in this respect.

As used herein, the term “comprise” or “include” and their variations are open-ended, that is, “comprise but not limited to” and “include but not limited to”. The term “based on” is “based at least in part on”. The term “an embodiment” means “at least one embodiment”. The term “another embodiment” means “at least one further embodiment”. The term “some embodiments” means “at least some embodiments”. Definitions for other terms are given in the description below.

It should be noted that concepts such as “first” and “second” mentioned in the disclosure are merely used to distinguish different apparatuses, modules or units, and are not used to limit the order of functions executed by these apparatuses, modules or units or their interdependence.

It should be noted that the modification with “a” and “an” in the disclosure is intended to be illustrative rather than limitative, and should be understood by those skilled in the art as “one or more” unless the context clearly dictates otherwise.

The names of messages or information exchanged between a plurality of apparatuses in the embodiments of the disclosure are merely for illustrative purposes, and are not intended to limit the scope of these messages or information.

The solutions provided in embodiments of the disclosure will be described in detail below with reference to the accompanying drawings.

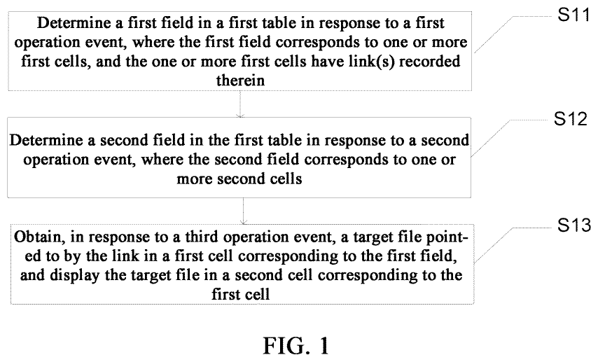

As shown in FIG. 1, FIG. 1 is a flowchart of a method for processing information according to an embodiment of the disclosure. The method includes the following steps.

S11: Determining a first field in a first table in response to a first operation event, where the first field corresponds to one or more first cells, and the one or more first cells have link(s) recorded therein.

S12: Determining a second field in the first table in response to a second operation event, where the second field corresponds to one or more second cells.

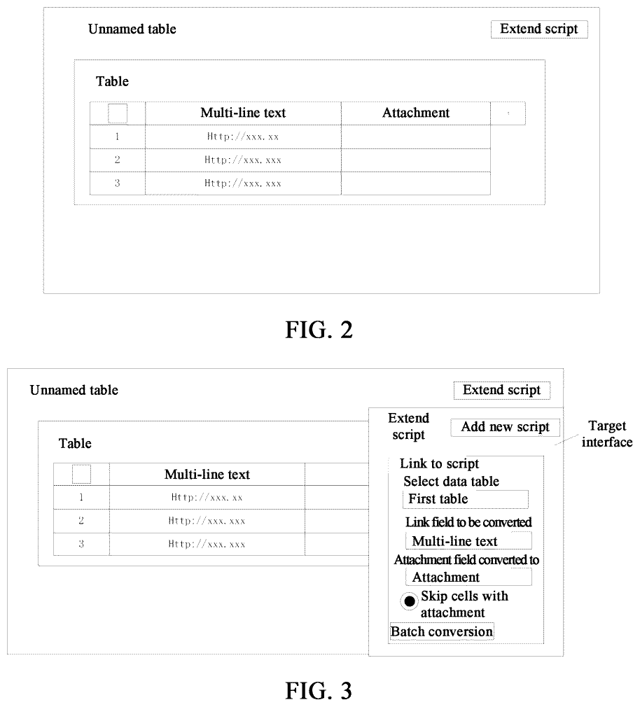

In some embodiments, an execution end of the method provided in the disclosure may be a terminal. The terminal may be, for example, a mobile phone, a tablet, a computer, or a server, etc. Specifically, the method can be used for communication clients or browsers. In some embodiments, the first operation event and/or the second operation event may include one or more operations. The first operation event and/or the second operation event may include, for example, a selection operation, so as to select a field in the first table. The first operation event and/or the second operation event may also include an input operation, and a user may manually input a name of the first field and/or the second field. The first table may be a table in an online document or an offline document. The document to which the first table belongs may be a table document or a non-table document, for example, may be a table in a text document. A field is an attribute of a cell. The field defines a type of a cell content that can be carried in a cell corresponding to the field. Usually, a column or row of cells has the same field. The cells in the column where the field is located can be the cells corresponding to the field. For example, as shown in FIG. 2, “multi-line text” and “attachment” are two fields of the table in FIG. 2. A cell in the column where “multi-line text” is located is a cell corresponding to the “multi-line text” field. A cell in the column where the “attachment” field is located is a cell corresponding to the “attachment” field. The first field corresponds to one or more first cells. The second field corresponds to one or more second cells. The first cell corresponding to the first field has the same links or not. For example, as shown in FIG. 2, a link is recorded in a cell corresponding to the “multi-line text” field. One or more links may be provided in one cell. The number of links in different cells may be the same or not. Different cells may have the same link or different links. The first field and/or the second field may be any field in the first table, and the cell corresponding to the first field needs to have a link.

S13: Obtaining, in response to a third operation event, a target file pointed to by the link in the first cell corresponding to the first field, and display the target file in a second cell corresponding to the first cell.

In some embodiments, the third operation event may include one or more operations. For example, the third operation event may be a conversion operation. After the third operation event occurs, the target file pointed to by the link in the first cell corresponding to the first field may be automatically downloaded. That is, one or more target files may be provided. The number of target files may be the same as the number of links. A target file may be one or more of text, a picture, music, a video, a web page, etc. Then, the target file may be stored in a form of an attachment and displayed in a cell of the first table. In some embodiments, the attachment may be rendered in the cell of the first table, such that the content of the attachment may be viewed directly. For example, when the target file is a picture, the picture may be displayed directly. In some other embodiments, a thumbnail image of the target file may be displayed in the second cell of the first table. Detailed contents of the target file may be displayed after the thumbnail image is triggered.

In some embodiments, the user may write a link into a cell of the table and view the target file pointed to by the link when desired. However, since the target file is located outside the first table, the content of the target file may be modified at any time, which may cause security problems, and since the target file is stored outside, when the user accesses the target file pointed to by the link, user experience may be influenced by factors such as region and network. Furthermore, the user needs to download a corresponding target file for each link separately, which also causes efficiency reduction and poor use experience. In some embodiments of the disclosure, after the first field is determined, the target files pointed to by the links in the first cells corresponding to the first field may be downloaded in batches through the third operation event, and the user does not need to execute the operation of downloading the target files corresponding to the links and writing the same into the first table one by one, such that the efficiency of the user in processing the target files pointed to by the links and converting the target files is improved. Moreover, since a target file is downloaded and displayed in the first table, security of the content of the target file is improved, and content provider of the target file is prevented from modifying the content corresponding to the link. An influence of factors such as region or network on the user during visiting is avoided.

In some embodiments of the disclosure, it is implemented that the links are converted in batches and written into the first table, such that operation efficiency of the user is improved, and the user does not need to manually download the target files pointed to by the links one by one.

In some embodiments of the disclosure, displaying the target file in a second cell corresponding to the first cell includes: storing the target file in the second cell as an attachment. In some embodiments, the target file pointed to by the link is displayed in a second cell corresponding to the second field in a record where the link is located, and the first cell corresponds to a second cell located in the same record.

In some embodiments, after the target files pointed to by the links are downloaded in batches, the target files are stored in the second cells corresponding to the second field in a form of attachments, and a target file is stored in a same record as the link corresponding thereto. In some embodiments, a record may refer to a row of data in the first table. That is, a first cell may correspond to a second cell located in the same row. For example, as shown in FIG. 2, rows where the numbers 1, 2 and 3 are located in FIG. 2 are three records. One record may have a plurality of cells, and the cells in one record may have different field attributes. The target file corresponding to the link in the first cell in the row of data where the number 1 is located is stored in the second cell corresponding to the second field in this row of data. For example, when the second field is an “attachment” field, the target file is stored in a second cell corresponding to the “attachment” field in the row of data, that is, a third cell from left to right in the row of data where the number 1 is located. In some embodiments, a target file is stored in a second cell, such that the target file is stored at a specified position, and the target file and the link corresponding to the target file are located in the same record, such that the user can intuitively understand a corresponding relation between a link and a target file.

In some embodiments of the disclosure, before determining the first field in the first table in response to the first operation event, the method further includes: displaying, in response to a trigger operation on a target plug-in in a first table page, a target interface in the first table page, where the target interface has a first region used for inputting or selecting a first field where a link is located, and a second region used for inputting or selecting a second field where an attachment is displayed. In some embodiments, determining the first field in the first table includes: obtaining content input or selected in the first region, thereby determining the first field. In some embodiments, determining the second field in the first table includes: obtaining content input or selected in the second region, thereby determine the second field.

In some embodiments, as shown in FIG. 2, “Extend script” in an upper right corner of FIG. 2 is a target plug-in, and the target plug-in can be triggered by clicking, etc. Accordingly, a target interface may be displayed as shown on a right side of FIG. 3. The target interface has a first region where a link field (that is, the first field) to be converted is selected, and a second region where an attachment field (that is, the second field) converted to is selected. The first field and the second field may be selected or input in the first region and the second region. In some embodiments, as shown in FIG. 3, the target interface further has a third region used for inputting or selecting the first table. That is, a region where the “First table” is located below “Select data table” in FIG. 3 is the third region. The fields in the first region and the second region are limited to fields of the table in the third region. In some embodiments, fields in the first table are automatically identified after the first table is input or selected in the third region. A prompt is displayed in a case that a field not in the first table is input in the first region and the second region. In some embodiments, as shown in FIG. 3, the target interface has a target option (option “Skip cells with attachment” in FIG. 3) displayed therein, and the target option is used for determining, when obtaining the target file pointed to by the link, whether to obtain a target file pointed to by a link in a first cell corresponding to the second cell where a target file is already displayed. For example, when the target option is selected, in a case that an attachment already exists in a second cell corresponding to the second field before the third operation event, the target file pointed to by the link in the first cell corresponding to the second cell is not to be obtained, and only the target file pointed to by the link in the first cell corresponding to the second cell without an attachment is obtained.

In some embodiments of the disclosure, obtaining, in response to the third operation event, the target file pointed to by the link in the first cell corresponding to the first field includes: obtaining, in response to the third operation event, the link in the first cell corresponding to the first field; determining whether the link is a valid link by using a preset regular expression; and obtaining the target file pointed to by the link in a case that the link is a valid link.

In some embodiments, the third operation event may be triggering a target control by clicking, etc., and the target control may be a “Batch conversion” control in the target interface in FIG. 3. By triggering the target control, the target file can be downloaded and uploaded to the first table and written into the second cell corresponding to the second field. Step S13 may specifically includes: monitoring a trigger operation on the target control, calling a response function after the target control is triggered; calling an interface of the target plug-in to obtain a link in each of the first cells corresponding to the first field; then determining whether the link is valid using a regular expression; displaying a prompt in a case that the link is invalid; and downloading the target file pointed to by the link through a http request in a case that the link is valid, then calling an upload interface of a target script to upload the target file to the first table, writing the uploaded target file into a second cell corresponding to the specified second field, and perform rendering, so as to display content of the target file (as shown in FIG. 4, a thumbnails of the uploaded target files are displayed in the cells in a column where the “Attachment” field is located, and the target files themselves may also be displayed). In some embodiments, by setting a regular expression, only target files pointed to by valid links in the links may be downloaded. When invalid links exist in the links, a prompt may be displayed to inform which links are invalid links. In some embodiments of the disclosure, a target file stored in the first table may be attached with a timestamp, that is, a time at which the target file was downloaded.

In some embodiments of the disclosure, in a case that a same link exists in the links in the first cells corresponding to the first field, when the target files pointed to by the links in the first cells corresponding to the first field are obtained, the target file pointed to by the same link is downloaded only once.

In some embodiments, there may be two or more same links in the links, and these links point to the same target file. In this case, the target file pointed to by the same links only needs to be downloaded once. This can reduce the download time and bandwidth usage, so as to increase the download rate.

In some embodiments of the disclosure, in a case that a plurality of same links exist in a same first cell corresponding to the first field, a target file corresponding to any of the plurality of same links is displayed in a second cell of the second field corresponding to the first cell. In some embodiments, a plurality of links exist in one first cell, but same links may exist in the plurality of links. In this case, when target files corresponding to the links are displayed, only one target file is displayed to correspond to the same links.

In some embodiments of the disclosure, in a case that same links exist in different first cells corresponding to the first field, a target file corresponding to each of the same links is displayed in a second cell of the second field corresponding to the first cell.

In some embodiments, in a case that two or more same links exist in the links of different first cells, two or more same target files corresponding to the different first cells need to be stored in the first table. That is, the number of the same links in different first cells (assuming that there are no same links in any of the first cells) is N, then N copies of the target file pointed to by the same links need to be stored in the first table N. The N copies of the target file can be independent of each other, such that modification of one of the copies by the user does not influence other copies of the same target file. The N copies of the target file can also be interrelated. Modification made to one of them can be synchronized to other copies of the same target file, such that user operations can be reduced, and the need to modify each of them is eliminated.

In some embodiments, the method further includes: modifying a first target file in the first table in response to a fourth operation event; in a case that the first table has a second target file with the same content as the first target file before modification, displaying prompt information to prompt whether to execute same modification on the second target file as the first target file; and executing or not executing the same modification on the second target file as on the first target file based on a fifth operation event executed on the prompt information, where the first target file and the second target file are the target files displayed in the first table.

In some embodiments, the first target file and the second target file may be the same target file pointed to by two or more same links. For example, the same target file may be a target file pointed to by same links in two or more different first cells. The same target file is stored in the first table as two or more attachments, that is, contents of the first target file and the second target file before modification are the same. The fourth operation event may be a modification operation on the first target file. After modification is performed on the first target file, prompt information may be displayed to prompt whether to synchronize the modification to the second target file. The user may execute a fifth operation event to select to synchronize the modification to the second target file or not. Whether to modify the second target file is determined based on a result of the fifth operation event, that is, based on whether the user selects to synchronize the modification to the second target file. In a case that the user selects to synchronize the modification to the second target file, the same modification is executed on the second target file as on the first target file; and in a case that the user selects not to synchronize the modification to the second target file, the second target file remains unmodified. In some embodiments of the disclosure, user operations may be reduced, and modification to one target file may be synchronized to all other same target files.

In some embodiments of the disclosure, the method further includes: in response to a sixth operation event on the link in the first cell corresponding to the first field, opening the target file corresponding to the link in the first table.

In some embodiments, a target file stored outside the first table may be viewed by, for example, clicking on a link in a first cell corresponding to the first field to access the link. However, the user may want to access the target file stored in the first table. In this case, the user may select to access the target file directly by, for example, clicking on the target file in the cell corresponding to the second field, or may access the target file by executing the sixth operation event on the link in the first cell corresponding to the first field. The sixth operation event may include, for example, invoking options by right-clicking on the link, and selecting an option to access the target file stored in the first table from the options. That is, in some embodiments of the disclosure, a target file outside the first table may be accessed through a link, and a target file stored in a second cell may also be accessed through a link, which facilitates comparison by the user. Also, when the second field is away from the first field and the user is currently located near the first field, the user does not need to move to the second field, and the target file in the first table may be accessed directly through the link in the first cell corresponding to the first field, such that user operations are facilitated.

In some embodiments, obtaining the target file pointed to by the link in the first cell corresponding to the first field, and displaying the target file in the second cell corresponding to the second field of the first table, include: obtaining a respective target file pointed to by a link in each of the first cells corresponding to the first field, and displaying the target file in a second cell corresponding to the second field of the first table; or, skipping, in response to the target file or another file other than the target file existing in the second cell, a link in the first cell corresponding to the second cell where the target file exists, and not modifying content of the second cell where the target file or the other file other than the target file exist. A target file pointed to by a link in the first cell corresponding to the second cell where no target file exists is obtained, and the target file is displayed in the second cell corresponding to the first cell.

In some embodiments, when the target files corresponding to the links are obtained, target files pointed to by all links in all the first cells may be obtained, and alternatively, some of the links may be skipped. For example, in a case that a target file already exists in a second cell, the link in the first cell in the record where the second cell is located may be skipped. Specifically, as shown in FIG. 3, whether to obtain the target files pointed to by all links may be selected through the target option (“Skip cells with attachment”) in the target interface. When the target option is in a first state, target files pointed to by all links in all the first cells are obtained. And alternatively, some of the links may be skipped. When the target option is in a second state, the link in the first cell in the record where the second cell is located is skipped.

In some embodiments, the field attribute of the first field is a link field, and the field attribute of the second field is an attachment field. The field attribute may identify a type of data stored in a cell corresponding to a field. For example, the link field identifies that the type of data stored in a cell corresponding to a field is a link. Similarly, the attachment field identifies that the type of data stored in a cell corresponding to a field is an attachment.

In some embodiments of the disclosure, the target file corresponding to the link is downloaded and uploaded to the first table to avoid security violation caused by tampering of data. The target file corresponding to the link is stored in the first table to avoid attachments unavailability caused by factors such as regions and networks. The links are converted into attachments in batches and stored, such that the operation efficiency of the user is improved.

Some embodiments of the disclosure further provide an apparatus for processing information. The apparatus includes:
a determination unit configured to determine a first field in a first table in response to a first operation event, where the first field corresponds to one or more first cells, and the one or more first cells have links recorded therein, and
the determination unit is further configured to determine a second field in the first table in response to a second operation event, where the second field corresponds to one or more second cells; and
a control unit configured to obtain, in response to a third operation event, a target file pointed to by the link in the first cell corresponding to the first field, and display the target file in a second cell corresponding to the first cell.

In some embodiments, displaying the target file in a second cell corresponding to the first cell includes: storing the target file in the second cell as an attachment.

In some embodiments, the target file pointed to by the link is displayed in a second cell corresponding to the second field in a record where the link is located, and the first cell corresponds to a second cell located in the same record.

In some embodiments, the apparatus further includes a display unit configured to display, in response to a trigger operation on a target plug-in in a first table page, a target interface in the first table page before determining the first field in the first table in response to the first operation event, where the target interface has a first region used for inputting or selecting a first field where a link is located, and a second region used for inputting or selecting a second field where an attachment is displayed.

In some embodiments, determining a first field in a first table includes: obtain content input or selected in the first region, and determine the first field.

In some embodiments, the step of determining a second field in the first table includes: obtain content input or selected in the second region, and determine the second field.

In some embodiments, the target interface further has a third region used for inputting or selecting the first table.

Fields in the first region and the second region are restricted to fields of the first table in the third region.

In some embodiments, the target interface further has a target option, and the target option is used for determining, when obtaining the target file pointed to by the link, whether to obtain a target file pointed to by a link in a first cell corresponding to the second cell where the target file is already displayed.

In some embodiments, the obtaining, in response to a third operation event, a target file pointed to by a link in the first cell corresponding to the first field includes:
obtaining, in response to the third operation event, the link in the first cell corresponding to the first field;
determining whether the link is a valid link by using a preset regular expression; and
obtaining the target file pointed to by the link in a case that the link is a valid link.

In some embodiments, in a case that a plurality of same links exist in a same first cell corresponding to the first field, displaying a target file corresponding to any of the plurality of same links in a second cell of the second field corresponding to the first cell.

In some embodiments, in a case that same links exist in different first cells corresponding to the first field, displaying a target file corresponding to each of same links in a second cell of a second field corresponding to the first cell.

In some embodiments, the control unit is further configured to: modify a first target file in the first table in response to a fourth operation event;
display, in a case that the first table has a second target file with the same content as the first target file before modification, prompt information to prompt whether to execute the same modification on the second target file as on the first target file; and
execute or not execute the same modification on the second target file as on the first target file based on a fifth operation event executed on the prompt information, where
the first target file and the second target file are the target files displayed in the first table.

In some embodiments, the control unit is further configured to open, in response to a sixth operation event on the link in the first cell corresponding to the first field, the target file corresponding to the link in the first table.

In some embodiments, obtaining a target file pointed to by a link in a first cell corresponding to the first field and displaying the target file in a second cell corresponding to the second field of the first table includes:
obtaining a target file pointed to by a link in each of the first cells corresponding to the first field, and display the target file in the second cell corresponding to the second field of the first table; or
skipping, in response to the target file existing in the second cell, a link in the first cell corresponding to the second cell where the target file exists, obtaining a target file pointed to by a link in the first cell corresponding to the second cell where no target file exists, and display the target file in the second cell corresponding to the first cell.

In some embodiments, a field attribute of the first field is a link field, and a field attribute of the second field is an attachment field.

Since the embodiments of the apparatuses correspond to the method embodiments basically, reference can be made to the description of the method embodiments. The apparatus embodiments described above are merely schematic, the modules illustrated as separate modules may be separate or not. Some or all of the modules may be selected according to actual needs to achieve the purpose of the solutions of the embodiments. This can be understood and implemented by those of ordinary skill in the art without making creative efforts.

The method and apparatus of the disclosure have been described above based on embodiments and application instances. Moreover, the disclosure further provides an electronic device and a computer-readable storage medium. The electronic device and the computer-readable storage medium are described below.

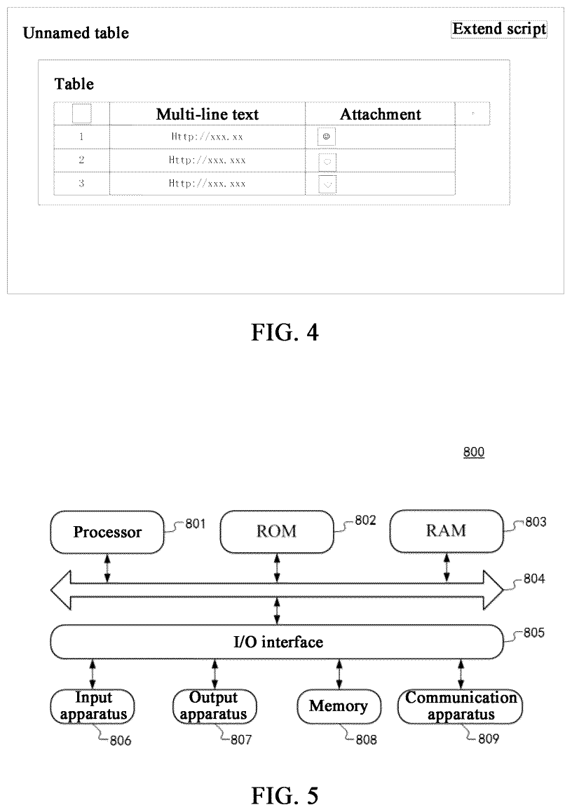

With reference to FIG. 5 below, a schematic structural diagram of an electronic device (for example, a terminal device or a server) 800 suitable for implementing an embodiment of the disclosure is shown. The terminal device in the embodiment of the disclosure may include, but is not limited to, mobile terminals such as a mobile phone, a notebook computer, a digital broadcast receiver, a personal digital assistant (PDA), a portable android device (PAD), a portable multimedia player (PMP), an in-vehicle terminal (for example, an in-vehicle navigation terminal), etc., and fixed terminals such as a digital television (TV), a desktop computer, etc. The electronic device illustrated in the figure is merely an instance and should not impose any limitation on the functions and scope of use of the embodiments of the disclosure.

The electronic device 800 may include a processor (for example, a central processing unit, a graphics processing unit, etc.) 801 that may execute various appropriate actions and processes according to programs stored in a read-only memory (ROM) 802 or programs loaded from a storage apparatus 808 into a random-access memory (RAM) 803. The RAM 803 also stores various programs and data needed for the operations of the electronic device 800. The processor 801, the ROM 802, and the RAM 803 are connected to each other by means of a bus 804. An input/output (I/O) interface 805 is also connected to the bus 804.

Typically, the following apparatuses may be connected to the I/O interface 805: an input apparatus 806 including, for example, a touch screen, a touch pad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to be in wireless or wired communication with other devices to exchange data. While the figure illustrates an electronic device 800 having various apparatuses, it should be understood that not all of the illustrated apparatuses are required to be implemented or provided. More or fewer apparatuses may alternatively be implemented or provided.

In particular, according to embodiments of the disclosure, a processes described above with reference to the flowcharts may be implemented as a computer software program. For example, embodiments of the disclosure include a computer program product. The computer program product includes a computer program carried on a computer-readable medium, and the computer program includes program code for executing the method illustrated in the flowchart. In such embodiments, the computer program may be downloaded and installed from a network by means of the communication apparatuses 809, or installed from the storage device 808, or installed from the ROM 802. When executed by the processor 801, the computer program executes the above-described functions defined in the method of the embodiment of the disclosure.

It should be noted that the computer-readable medium in the disclosure may be a computer-readable signal medium or a computer-readable storage medium, or any combination of a computer-readable signal medium and a computer-readable storage medium. The computer-readable storage medium may include, but is not limited to, an electronic, magnetic, optical, electromagnetic, infrared, or semiconductor system, apparatus, or device, or any combination of the foregoing. More specific instance of the computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the disclosure, the computer-readable storage medium may be any tangible medium that includes or stores a program for use by or in conjunction with an instruction execution system, apparatus, or device. In the disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can send, propagate, or transmit a program for use by or in conjunction with an instruction execution system, apparatus, or device. Program code included on a computer-readable medium may be transmitted by means of any suitable medium, including, but not limited to, wires, fiber optic cables, radio frequency (RF), etc., or any suitable combination of the foregoing.

In some embodiments, a client side and a server may communicate by using any currently known or future developed network protocol, such as a hypertext transfer protocol (HTTP), and may be interconnected with any form or medium of digital data communication (for example, a communication network). Instances of communication networks include a local area network (LAN), a wide area network (WAN), Internet work (for example, the Internet), and an end-to-end network (for example, an ad hoc end-to-end network), as well as any currently known or future developed network.

The computer-readable medium may be included in the above electronic device, and may also exist independently without being assembled into the electronic device.

The computer-readable medium carries one or more programs. The one or more programs, when executed by the electronic device, causes the electronic device executes the method according to the disclosure.

A computer program code for performing operations of the disclosure may be written in one or more programming languages, or combinations of the programming languages. The programming languages include target-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality, and operations possibly implemented by the systems, methods, and computer program products according to various embodiments of the disclosure. In this regard, each block in the flowcharts or block diagrams may represent a module, a program segment, or part of code, and the module, the program segment, or the part of code includes one or more executable instructions for implementing a specified logical function. It should also be noted that in some alternative implementations, a function noted in a block may occur in a different order than an order noted in the figures. For example, two consecutive blocks may actually be executed substantially in parallel, or in a reverse order sometimes, depending on a function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The units described in the embodiment of the disclosure may be implemented in software or hardware. The name of a unit does not constitute a qualification of the unit itself under certain circumstances.

The functions described above herein may be executed at least partially by one or more hardware logic components, for example, exemplary types of the hardware logic components that may be used include: a field programmable gate array (FPGA), an application specific integrated circuit (ASIC), an application specific standard product (ASSP), a system on chip (SOC), a complex programmable logic device (CPLD), etc. in a non-restrictive way.

In the context of the disclosure, the machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific instance of the machine-readable storage medium may include an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the disclosure, a method for processing information is provided. The method includes:
determining a first field in a first table in response to a first operation event, wherein the first field corresponds to one or more first cells, and the one or more first cells have links recorded therein;
determining a second field in the first table in response to a second operation event, wherein the second field corresponds to one or more second cells; and
obtaining, in response to a third operation event, a target file pointed to by a link in a first cell corresponding to the first field, and displaying the target file in a second cell corresponding to the first cell.

According to one or more embodiments of the disclosure, a method for processing information is provided, where displaying the target file in a second cell corresponding to the first cell includes: storing the target file in the second cell as an attachment;
and/or;
where the target file pointed to by the link is displayed in a second cell corresponding to the second field in a record where the link is located, and the first cell corresponds to a second cell located in a same record.

According to one or more embodiments of the disclosure, a method for processing information is provided, where before determining a first field in a first table in response to a first operation event, the method further includes:
displaying, in response to a trigger operation on a target plug-in in a first table page, a target interface in the first table page, wherein the target interface has a first region used for inputting or selecting a first field where a link is located, and a second region used for inputting or selecting a second field where an attachment is displayed.

According to one or more embodiments of the disclosure, a method for processing information is provided, where determining a first field in a first table includes: obtaining content input or selected in the first region, and determine the first field;
and/or,
where determining a second field in the first table includes: obtaining a content input or selected in the second region to determine the second field.

According to one or more embodiments of the disclosure, a method for processing information is provided, where the target interface further has a third region used for inputting or selecting the first table;
and fields in the first region and the second region are restricted to fields of the first table in the third region;
and/or;
the target interface further has a target option, and the target option is used for determining, when obtaining a target file pointed to by the link, whether to obtain a target file pointed to by a link in the first cell corresponding to a second cell where a target file is already displayed.

According to one or more embodiments of the disclosure, a method for processing information is provided, where obtaining, in response to a third operation event, a target file pointed to by the link in the first cell corresponding to the first field includes:
obtaining, in response to the third operation event, the link in the first cell corresponding to the first field;
determining whether the link is a valid link by using a preset regular expression; and
obtaining the target file pointed to by the link in a case that the link is a valid link.

According to one or more embodiments of the disclosure, a method for processing information is provided, where in a case that a plurality of same links exist in a same first cell corresponding to the first field, a target file corresponding to any one of the plurality of same links is displayed in a second cell of the second field corresponding to the first cell;
and/or, in a case that same links exist in different first cells corresponding to the first field, a target file corresponding to each of the same links is displayed in a second cell of a second field corresponding to the first cell.

According to one or more embodiments of the disclosure, a method for processing information is provided. The method further includes:
modifying a first target file in the first table in response to a fourth operation event;
displaying, in a case that the first table has a second target file with same content as the first target file before modification, prompt information to prompt whether to execute same modification on the second target file as on the first target file; and
executing or not executing, based on a fifth operation event executed on the prompt information, the same modification on the second target file as on the first target file;
where the first target file and the second target file are target files displayed in the first table.

According to one or more embodiments of the disclosure, a method for processing information is provided. The method further includes:
opening, in response to a sixth operation event on the link in the first cell corresponding to the first field, the target file corresponding to the link in the first table.

According to one or more embodiments of the disclosure, a method for processing information is provided, where obtaining a target file pointed to by a link in a first cell corresponding to the first field and displaying the target file in a second cell corresponding to the second field of the first table include:
obtaining a target file pointed to by a link in each of the first cells corresponding to the first field, and displaying the target file in the second cell corresponding to the second field of the first table; or
skipping, in response to the target file existing in the second cell, a link in a first cell corresponding to the second cell where the target file exists, obtaining a target file pointed to by a link in the first cell corresponding to the second cell where no target file exists, and displaying the target file in a second cell corresponding to the first cell.

According to one or more embodiments of the disclosure, a method for processing information is provided, where a field attribute of the first field is a link field, and a field attribute of the second field is an attachment field.

According to one or more embodiments of the disclosure, an apparatus for processing information is provided. The apparatus includes:
a determination unit, configured to determine a first field in a first table in response to a first operation event, wherein the first field corresponds to one or more first cells, and the one or more first cells have links recorded therein, and the determination unit is further configured to determine a second field in the first table in response to a second operation event, and the second field corresponds to one or more second cells; and
a control unit, configured to obtain, in response to a third operation event, a target file pointed to by a link in a first cell corresponding to the first field, and display the target file in a second cell corresponding to the first cell.

According to one or more embodiments of the disclosure, an electronic device is provided. The electronic device includes at least one memory and at least one processor.

The at least one memory is configured to store program code, and the at least one processor is configured to call the program code stored in the at least one memory to execute the method according to any of the above items.

According to one or more embodiments of the disclosure, a computer-readable storage medium is provided. The computer-readable storage medium stores program code. The program code, when executed by a processor, causes the processor to execute the above method.

The above description is merely illustrative of preferred embodiments of the disclosure and principles of the technology employed. It should be understood by those skilled in the art that the disclosed scope involved in the disclosure is not limited to the technical solutions in which the above-described technical features are specifically combined, but encompasses other technical solutions in which the above-described technical features or equivalent features thereof are arbitrarily combined without departing from the concept of the disclosure, for example, technical solutions formed by interchanging the features described above with (non-limitative) technical features disclosed in the disclosure that have similar functions.

Furthermore, although operations are depicted in a particular order, this should not be understood as requiring that such operations be performed in the particular order shown or in a sequential order. In certain circumstances, multitasking and parallel processing may be advantageous. Similarly, although several specific implementation details are included in the above discussion, these details should not be construed as limitations on the scope of the disclosure. Some features that are described in the context of separate embodiments may also be implemented in combination in a single embodiment. Conversely, various features described in the context of a single embodiment can also be implemented in multiple embodiments separately or in any suitable sub-combination manner.

Although the subject matter has been described in language specific to structural features and/or methodological logical actions, it should be understood that the subject matter defined in the appended claims is not necessarily limited to the specific features or actions described above. On the contrary, the specific features and actions described above are merely instance forms of implementing the claims.

I/We claim:

1. A method for processing information, comprising:
determining a first field in a first table in response to a first operation event, wherein the first field corresponds to one or more first cells, and the one or more first cells have links recorded therein;
determining a second field in the first table in response to a second operation event, wherein the second field corresponds to one or more second cells; and
obtaining, in response to a third operation event, a target file pointed to by a link in a first cell corresponding to the first field, and displaying the target file in a second cell corresponding to the first cell.

2. The method according to claim 1, wherein displaying the target file in the second cell corresponding to the first cell comprises storing the target file in the second cell as an attachment; and/or
wherein the target file pointed to by the link is displayed in a second cell corresponding to the second field in a record where the link is located, and the first cell corresponds to a second cell located in a same record.

3. The method according to claim 1, wherein the method further comprises before determining the first field in the first table in response to the first operation event:
displaying, in response to a trigger operation on a target plug-in in a first table page, a target interface in the first table page, wherein the target interface has a first region used for inputting or selecting a first field where a link is located, and a second region used for inputting or selecting a second field where an attachment is displayed.

4. The method according to claim 3, wherein determining the first field in the first table comprises: obtaining content input or selected in the first region to determine the first field; and/or
wherein determining the second field in the first table comprises: obtaining content input or selected in the second region to determine the second field.

5. The method according to claim 3, wherein the target interface further has a third region used for inputting or selecting the first table, and fields in the first region and the second region are restricted to fields of the first table in the third region; and/or
wherein the target interface further has a target option, and the target option is used for determining, when obtaining the target file pointed to by the link, whether to obtain a target file pointed to by a link in the first cell corresponding to a second cell where a target file is already displayed.

6. The method according to claim 1, wherein obtaining, in response to the third operation, the target file pointed to by the link in the first cell corresponding to the first field, comprises:
obtaining, in response to the third operation event, the link in the first cell corresponding to the first field;
determining whether the link is a valid link by using a preset regular expression; and
obtaining the target file pointed to by the link in a case that the link is a valid link.

7. The method according to claim 1, further comprising:
displaying, in a case that a plurality of same links exist in a same first cell corresponding to the first field, a respective target file corresponding to any of the plurality of same links in a second cell of the second field corresponding to the first cell; and/or
displaying, in a case that same links exist in different first cells corresponding to the first field, a respective target file corresponding to each of the same links in a second cell of the second field corresponding to the first cell.

8. The method according to claim 1, further comprising:
modifying a first target file in the first table in response to a fourth operation event;
displaying, in a case that the first table has a second target file with same content as the first target file before modification, prompt information to prompt whether to execute same modification on the second target file as on the first target file; and
executing or not executing, based on a fifth operation event executed on the prompt information, the same modification on the second target file as on the first target file;
and wherein the first target file and the second target file are target files displayed in the first table.

9. The method according to claim 1, further comprising:
opening, in response to a sixth operation event on the link in the first cell corresponding to the first field, the target file corresponding to the link in the first table.

10. The method according to claim 1, wherein obtaining the target file pointed to by the link in the first cell corresponding to the first field and displaying the target file in the second cell corresponding to the second field of the first table comprises:
obtaining a respective target file pointed to by a link in each of the first cells corresponding to the first field, and displaying the respective target file in a second cell corresponding to the second field of the first table; or
skipping, in response to the target file or another file existing in the second cell, a link in a first cell corresponding to the second cell where the target file exists.

11. The method according to claim 1, wherein a field attribute of the first field is a link field, and a field attribute of the second field is an attachment field.

12. An electronic device, comprising:
at least one memory and at least one processor;
wherein the at least one memory is configured to store program code, and the at least one processor is configured to call the program code stored in the at least one memory to:
determine a first field in a first table in response to a first operation event, wherein the first field corresponds to one or more first cells, and the one or more first cells have links recorded therein;
determine a second field in the first table in response to a second operation event, wherein the second field corresponds to one or more second cells; and
obtain, in response to a third operation event, a target file pointed to by a link in a first cell corresponding to the first field, and display the target file in a second cell corresponding to the first cell.

13. The electronic device according to claim 12, wherein the at least one processor, when to display the target file in the second cell corresponding to the first cell, is to store the target file in the second cell as an attachment; and/or
wherein the target file pointed to by the link is displayed in a second cell corresponding to the second field in a record where the link is located, and the first cell corresponds to a second cell located in a same record.

14. The electronic device according to claim 12, wherein the at least one processor is further configured to call the program code to, before determining the first field in the first table in response to the first operation event:
display, in response to a trigger operation on a target plug-in in a first table page, a target interface in the first table page, wherein the target interface has a first region used for inputting or selecting a first field where a link is located, and a second region used for inputting or selecting a second field where an attachment is displayed.

15. The electronic device according to claim 14, wherein the at least one processor, when to determine the first field in the first table, is to: obtain content input or selected in the first region to determine the first field; and/or
wherein the at least one processor, when to determine the second field in the first table, is to: obtain content input or selected in the second region to determine the second field.

16. The electronic device according to claim 14, wherein the target interface further has a third region used for inputting or selecting the first table, and fields in the first region and the second region are restricted to fields of the first table in the third region; and/or
wherein the target interface further has a target option, and the target option is used for determining, when obtaining the target file pointed to by the link, whether to obtain a target file pointed to by a link in the first cell corresponding to a second cell where a target file is already displayed.

17. The electronic device according to claim 12, wherein the at least one processor, when to obtain the target file pointed to by the link in the first cell corresponding to the first field in response to the third operation, is to:
obtain, in response to the third operation event, the link in the first cell corresponding to the first field;
determine whether the link is a valid link by using a preset regular expression; and
obtain the target file pointed to by the link in a case that the link is a valid link.

18. The electronic device according to claim 12, wherein the at least one processor is further configured to call the program code to:
display, in a case that a plurality of same links exist in a same first cell corresponding to the first field, a respective target file corresponding to any of the plurality of same links in a second cell of the second field corresponding to the first cell; and/or
display, in a case that same links exist in different first cells corresponding to the first field, a respective target file corresponding to each of the same links in a second cell of the second field corresponding to the first cell.

19. The electronic device according to claim 12, wherein the program code, wherein the at least one processor is further configured to call the program code to:
modify a first target file in the first table in response to a fourth operation event;
display, in a case that the first table has a second target file with same content as the first target file before modification, prompt information to prompt whether to execute same modification on the second target file as on the first target file; and
execute or not execute, based on a fifth operation event executed on the prompt information, the same modification on the second target file as on the first target file;
and wherein the first target file and the second target file are target files displayed in the first table.

20. A non-transitory computer-readable storage medium storing program code, wherein the program code, when executed by a processor, causes the processor to execute:
determine a first field in a first table in response to a first operation event, wherein the first field corresponds to one or more first cells, and the one or more first cells have links recorded therein;
determine a second field in the first table in response to a second operation event, wherein the second field corresponds to one or more second cells; and
obtain, in response to a third operation event, a target file pointed to by a link in a first cell corresponding to the first field, and display the target file in a second cell corresponding to the first cell.
